(19) United States
(12) Patent Application Publication
(10) Pub. No.: US 2021/0142233 A1
(43) Pub. Date: May 13, 2021

(54) SYSTEMS AND METHODS FOR PROCESS MINING USING UNSUPERVISED LEARNING

(71) Applicant: UST Global (Singapore) Pte. Ltd., Singapore (SG)

(72) Inventors: Adnan Masood, Temple Terrace, FL (US); Krishnanunni Sreeramabhavan Unnikrishna Pillai, Kerala (IN)

(21) Appl. No.: 16/847,313

(22) Filed: Apr. 13, 2020

(30) Foreign Application Priority Data
Nov. 7, 2019 (IN) 201911045319

(51) Int. Cl. G06Q 10/06; G06N 3/08; G06N 20/10; G06K 9/62; G06F 17/16

(52) U.S. Cl. CPC G06Q 10/063; G06N 3/088; G06F 17/16; G06N 20/10; G06K 9/6215; G06N 3/084

(57) ABSTRACT

A system for discovering business processes using unsupervised learning is configured to: (a) receive multimodal event data from a plurality of sources, the multimodal event data including a plurality of event instances; (b) associate the multimodal event data with a vector representation, such that the plurality of event instances is represented as a plurality of event vectors; (c) correlate the plurality of event vectors using unsupervised learning to identify one or more processes; and (d) generate a process model script for the one or more processes.

### PRIORITY CLAIM

This application claims priority to India Provisional Application No. 201911045319, filed Nov. 7, 2019, which is hereby incorporated by reference herein in its entirety.

### TECHNICAL FIELD

The present disclosure relates to process mining using unsupervised learning and more specifically to systems and methods that extract micro tasks or events from structured and/or unstructured data and create one or more process flows from the micro tasks.

### BACKGROUND

A business enterprise includes multiple facets that work together to achieve a plurality of goals. The business enterprise can include multiple departments with different operational protocols, for example, the business enterprise can include an information technology (IT) department, an accounting department, a human resources (HR) department, a marketing department, a legal department, a research and development department, a customer service department, etc. Each of these departments can be subdivided into sub-departments which can be further subdivided into business units or groups.

Two or more of these business units or groups can coalesce to achieve an operational goal of the business enterprise. In some situations, the departmental subdivisions end up creating a logical hierarchical arrangement of the business units or groups, such that information flow between groups can be dictated by an escalation of matters from a group lower in the hierarchy to a group higher up in the hierarchy. As business enterprises mature and evolve in response to challenges they face within their industries, interactions between business groups can change. New business groups can be added, old ones can be removed, in-place protocols and processes used within and between business groups can be modified, new software can be adopted, departments can be outsourced, etc. These changes, if not monitored throughout a lifespan of a business enterprise, can result in numerous inefficiencies that can affect the business enterprise's effectiveness in meeting its goals. The present disclosure provides systems and methods that address difficulties relating to inefficiencies in monitoring processes within business enterprises.

### SUMMARY

Some implementations of the present disclosure provide a system for discovering business processes using unsupervised learning. The system includes a non-transitory computer-readable medium storing computer-executable instructions thereon such that when the instructions are executed, the system is configured to: (a) receive multimodal event data from a plurality of sources, the multimodal event data including a plurality of event instances; (b) associate the multimodal event data with a vector representation, such that the plurality of event instances is represented as a plurality of event vectors; (c) correlate the plurality of event vectors using unsupervised learning to identify one or more processes; and (d) generate a process model script for the one or more processes.

Some implementations of the present disclosure provide a method for discovering business processes using unsupervised learning including: (a) receiving multimodal event data from a plurality of sources, the multimodal event data including a plurality of event instances; (b) associating the multimodal event data with a vector representation, such that the plurality of event instances is represented as a plurality of event vectors; (c) correlating the plurality of event vectors using unsupervised learning to identify one or more processes; and (d) generating a process model script for the one or more processes.

The foregoing and additional aspects and implementations of the present disclosure will be apparent to those of ordinary skill in the art in view of the detailed description of various embodiments and/or implementations, which is made with reference to the drawings, a brief description of which is provided next.

### BRIEF DESCRIPTION OF THE DRAWINGS

The foregoing and other advantages of the present disclosure will become apparent upon reading the following detailed description and upon reference to the drawings.

FIG. 1 illustrates a block diagram of a system for discovering business processes according to some implementations of the present disclosure;

FIG. 2 illustrates an example process map showing at least two interrelated processes, according to some implementations of the disclosure; and

FIG. 3 is a flow diagram showing steps for discovering one or more processes using unsupervised learning, according to some implementations of the disclosure.

While the present disclosure is susceptible to various modifications and alternative forms, specific implementations have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the present disclosure as defined by the appended claims.

### DETAILED DESCRIPTION

Process compression is a method by which a business process realized as a workflow is optimized through decomposition by reducing, reordering, or changing the events, activities, connections, tasks, etc. involved in carrying out the subprocesses to execute or orchestrate a process, which can be graphically represented in Business Process Model and Notation (BPMN). Today, many aspects of a business process involve computers and data, and human interactions with those computers and data. Traditional approaches to optimize a business process myopically focus on automating specific activities of the business process, without taking a broader perspective of the entire business process for process compression opportunities from end-to-end (e.g., from a start event of a business process to an end event of the business process, and all activities in between).

Processes are comprised of tasks, and several methods have been proposed for process mining within an IT framework. For example, an IT infrastructure with thousands of servers can use distributed processing to respond to requests from customers. A specific request from a customer can be determined to take too long to handle because a dependent process running on another server is taking time. In IT, the dependent process can be identified as a bottleneck. Using statistical techniques, processes in an IT environment can be correlated to determine and anticipate a chain of disastrous events, that is, find defects or areas where an IT process can fail. That way, an IT team can intervene to effectively solve problems related to the chain or avoid the chain completely. The IT context uses log files from webservers, application servers, and service fabrics for the correlation.

Determining and anticipating the chain of disastrous events in traditional IT environments involves correlating events. Events are correlated using a rule based technique, a model based technique, a case based technique, a codebook, or a state transition correlation. None of these techniques for correlation involves learning. For example, the rule base technique involves following a graphed rule, the model based technique involves combining multiple rules to create a model, the case based technique involves creating branches in rules to accommodate case-by-case departures, the codebook is a set of rules, and the state transition correlation involves using automata in correlation. Furthermore, traditional techniques to event correlation are apriori. Traditional inputs to event correlators are set of events which include event logs, traces and sequences. Each event has a number of attributes or features (e.g., topological, numerical, text, etc.). Traditional outputs of event correlators are a list of ideal groups with characteristic metadata of each group. These traditional techniques do not learn, and their input sources are limited to structured log files.

Moreover, data involved in a business process increasingly is multimodal. Multimodal (or sometimes called multi-channel) data is data that has different modes from or by which the data is perceived or given meaning. For example, documents are one type of modality, the contents of which are perceived through human sight and then understanding. Speech or audio are another type of modality, which are perceived through human hearing. Images are another type of modality, which is perceived through human sight. Videos are another type of modality, which is perceived through a combination of human sight and hearing. Other modalities of data are generated by machines, such as tickets or event logs, which are meaningful to other machines. Ingesting these different modalities of data, which involve different sensory organs and indeed even other machines, creating associations or relationships among the multimodal data sets, and contextualizing the different modalities relative to one another are non-trivial, but highly critical endeavors in harnessing unsupervised learning and other artificial intelligence to expose insights. Insights exposed would be impossible or hopelessly inefficient for a human to try to do given the insurmountably massive volumes of multimodal data sets involved in a business process and the effectively infinite permutations to be parsed and assessed, which can number in the billions, trillions, and even higher.

Embodiments of the present disclosure provide a system and method utilizing unsupervised learning to discover business processes. Within a business enterprise, a business process can involve activities and tasks undertaken by more than one business group. The activities or tasks can be undertaken in sequential order or in parallel. The activities or tasks can require a coordination between two or more business groups. While implementing a process involving more than one business group, tasks within a first business group can be opaque to other business groups even though the other business groups need to coordinate with the first business group. Embodiments of the present disclosure identify and extract tasks and micro-tasks from multiple modalities of data (multimodal data). Incorporating multimodal data allows a holistic view of the business process, providing insights into activities undertaken in each business group involved in the business process.

Embodiments of the present disclosure provide a system and method for correlating events across multiple different modalities to map out business process instances and compare them for similarities, disjointedness, anomalies, and/or prediction. Correlating events to map out business process instances can provide a comprehensive view for building the business process. In some implementations, business process instances are represented as vectors such that computational techniques can be applied to the vectors to determine similarities between the business process instances. This computational approach to analyzing business processes enables combining statistical methods and event correlation using unsupervised learning.

Compared to the traditional IT environment previously described, embodiments of the present disclosure use unsupervised learning for process mining. Statistical methods of the IT environment break down because business processes are more complex than IT processes. For example, business processes involve multimodal data analysis of structured and unstructured data. Business processes can involve many events that do not lend themselves to actual sequences. As such, statistical methods of the IT environment are unable to effectively find sequences in business processes. Embodiments of the present disclosure use computational approaches therefore bypassing drawbacks associated with traditional statistical methods applied to the IT environment.

Embodiments of the present disclosure extract business process models by correlating individual business process events from multiple data sources to build a comprehensive view of a business process event sequence. The business process event sequence represents a singular business process instance as occurred in real life. Overlap and similarity between business process instances can be used to build a business process trunk. In some implementations, probabilities of departures from the business process trunk are determined based on the number of business process instances.

Process correlation performed according to some embodiments of the present disclosure can combine statistical event correlation and domain-based correlation by building vectorized representations of business processes. The vectorized representations can then be used to perform similarity analysis, correlation, and other process mining tasks for various domains, including but not limited to network security, intrusion detection systems, financial fraud detection, logistical outlier detection, etc.

FIG. 1 illustrates a block diagram of a system 100 for discovering business processes according to some implementations of the present disclosure. To simplify discussion, the singular form will be used for components identified in FIG. 1 when appropriate, but the use of the singular does not limit the discussion to only one of each such component. The system 100 includes a process mining server 102, one or more data sources 104, and a process script repository 106. Each of these components can be realized by one or more computer devices and/or networked computer devices. The computer devices include at least one processor with at least one non-transitory computer readable medium. The non-transitory computer readable medium can store computer-executable instructions that, when executed by the at least one processor, enables functionality described herein with respect to each of the aforementioned components. Examples of the process mining server 102 includes a computer, a server, an application specific integrated circuit, a field programmable gate array, or any combination thereof.

The one or more data sources 104 are depicted in FIG. 1 as data source 1, . . . data source n. The one or more data sources 104 can store structured and unstructured data. Examples of structured data include data logs, event logs, application logs, documents organized as key-value pairs, etc. Examples of unstructured data sources include images, sound inputs, and documents not organized as key-value pairs. The one or more data sources 104 can separate each data source by modalities. For example, data source 1 can include keystroke data logs, data source 2 can include Internet Information Services (IIS) log files, data source 3 can include Apache log files, data source 4 can include one or more application log files, data source 5 can include one or more standard operating procedure (SOP) manuals, data source 6 can include one or more screen capture logs, data source 7 can include one or more business process documents (BPDs), etc. The one or more data sources 104 can provide structured and unstructured data as log files, images, video, control sequences, etc.

In some implementations, a business enterprise collects keystroke activity in keystroke data logs. Employees' computers can include programs that monitor keystrokes and save the keystrokes in the keystroke data logs. An entry in the keystroke data log can include a timestamp for when a key was pressed, the specific key that was pressed, the user, cursor location, etc. A keystroke data log can contain entire context of application (i.e., application telemetry, active window information, process ID, executing process list, window index, positioning, activity status, vusial indices, mouse and other input devices information, application visuals, operating system attributes, etc.) Key press, mouse clicks, and other data collected can be application dependent. Although described in the context of keystrokes, logs of other human computer interaction (HCI) input devices are included. For example, mouse clicks, trackpad positions, touchscreen taps, voice inputs, augmented reality inputs, virtual reality inputs, mixed reality inputs, etc., can be monitored. Examples of employees' computers include desktop computers, laptop computers, smartphones, tablets, etc.

In some implementations, a business enterprise has one or more SOP manuals. The one or more SOP manuals can include tasks or events grouped into one or more processes. For example, an SOP manual in an HR department can include processes for declaring a position vacant, creating a newly established position, advertising a vacant position, etc. An SOP manual for security verification can include processes for clearing visitors to provide them access to resources, issuing badges to employees, tracking changes in employment status, etc. SOP manuals are usually written by humans, indicating steps that should be taken for each identified process.

Similar to the SOP manuals, in some implementations, a business enterprise has one or more BPDs. BPDs provide a sequence of activities for performing specific business services and can be used to standardize procedures and establish best practices. BPDs can include both text and images. In some cases, the images are flow charts with text descriptions of steps in the flow charts.

In some implementations, a business enterprise can collect one or more screen captures. Similar to keystroke logs, the business enterprise can have a background program installed on employees' computers to extract images in sequence as employees perform their duties. The screen captures can be analyzed as a video stream or can be analyzed as individual images.

In some implementations, a business enterprise can collect structured log data in the form of one or more of IIS log files, Apache log files, or application log files. These log files can include a timestamp, a user handle, a process name that the user was running, etc.

In some implementations, alongside the various data collected from the one or more data sources 104, a business enterprise can track control sequences or control level data. Control sequences include a sequence of controls that an employee or a user has used. Control sequences are a combination of keys and/or hot keys which can implicitly take part in process navigations. The control sequences can track or mirror other types of data collected. Control sequence data includes both control and printable characters. Control characters are non-printing characters (NPC) which represent a code point (or a number) in a character set that does not represent a written symbol. Printable characters are characters in the American Standard Code for Information Interchange (ASCII) printing range or more. Control sequence data including both control and printable characters allow a complete view of input sequence(s) provided by a user.

The process mining server 102 is configured to receive data from the one or more data sources 104 and discover one or more processes from the received data. The process mining server 102 can include one or more vectorizers 108 labeled as vectorizer 1, . . . vectorizer m. The one or more vectorizers 108 can include adaptors that allow reading of data obtained from the one or more data sources 104. For example, a vectorizer for converting keystroke logs to vectors can include adaptors that perform key-binning, a vectorizer for capturing text from images obtained via screen captures can include adaptors with optical character recognition (OCR), and so on.

In some implementations, the number of vectorizers in the one or more vectorizers 108 is equal to or less than the number of data sources in the one or more data sources 104 such that a same type of vectorizer can be used for a same type of data. For example, an application log file can have a similar structure to an IIS log file, therefore, a same vectorizer (e.g., vectorizer 1) can import data from the application log file and the IIS log file. On the other hand, the vectorizer 1 will be unable to import data from an image file since the vectorizer 1 is configured for structured text log files.

The one or more vectorizers 108 can tokenize data extracted via the adaptors. The one or more vectorizers 108 can then create vectors from the tokenized data. Once the vectors are created from the one or more vectorizers 108, vectors from disparate sources (from different data types) can be compared to each other in a same vector space.

The process mining server 102 can further include a process correlation engine 110. An engine is a combination of hardware and software configured to perform specific functionality. The process correlation engine 110 is configured to identify tasks and micro tasks from the vectorized data from the one or more vectorizers 108. The process correlation engine 110 can apply unsupervised learning to the vectorized data to predict and/or discover one or more processes from the vectorized data. For example, the process correlation engine 110 can use a long short-term memory (LSTM) artificial recurrent neural network (RNN) for classifying, processing, and making predictions based on the vectorized data. The vectorized data can retain time-series information such that the LSTM network can classify, process, and make predictions based on the time-series information in the vectorized data.

LSTM provides an advantage over feedforward neural networks since the vectorized data can include tasks or events that occur with an unknown duration separating occurrences. For example, individuals can take a varying amount of time to complete tasks since workers do not work at a constant speed, and individuals may prioritize other tasks or multi-task during a certain task. LSTM artificial RNNs allow memorizing events for a long period of time such that appropriate tasks relating to a process can be identified whenever they occur. LSTM is advantageous over traditional statistical techniques that break down when applied to business processes.

The process mining server 102 can further include a process coordination engine 112. The process coordination engine 112 can perform various tasks with the one or more processes identified by the process correlation engine 110. The process coordination engine 112 can, for example, perform process prediction, process conformance testing, process compression, process optimization, process clustering, or a combination thereof. The process coordination engine 112 can use various techniques in analyzing processes. For example, since events or tasks in a process are represented in vector space, the event vectors can be combined to form a process vector. Process vectors can lend themselves to vector analysis, such as dot products to determine similarity between two processes. Result of a dot product between two process vectors satisfying a similarity threshold can allow the process mining server 102 to determine that both process vectors refer to a same process. A process vector can also be called a process matrix, where the process matrix is comprised of multiple event vectors.

Enterprise process mining can be performed using embodiments of the present disclosure. To simplify discussion and unify concepts, examples will be used to illustrate process mining steps according to some implementations of the present disclosure. The examples are merely illustrative and are non-limiting.

Referring to FIG. 2, an example process map 200 showing at least two interrelated processes is provided according to some implementations of the present disclosure. The example process map 200 illustrates macro level tasks performed in adding an employee to business units within a business enterprise. Macro level tasks 202-214 are performed in a first business unit while macro level tasks 220-228 are performed in a second business unit. Descriptions of the macro level tasks and example data collected by the process mining server 102 are provided below.

Macro level task 202: Requestor logs in to computer and opens application A. Keystroke log data and other HCI data can be collected, and operating system control log indicating that application A is opened is collected.

Macro level task 204: Using application A, the requestor indicates that the employee should be added to the first business unit and the second business unit. Keystroke log data, screen capture data, and other HCI data can be collected. Application A's log can be collected indicating a control sequence in application A.

Macro level task 206: The employee's credentials are verified. Application A's log can indicate a request for credential verification of the employee in a database. Log files from the database can be collected which will include information relating to the computer running application A that requested the credential verification.

Macro level task 208: A second level verification by an individual is performed here once the database indicates that the employee's credentials are verified. Keystroke data, database log files, screen captures, etc., can be obtained. In some implementations, the verification is via a telephone or a video call, hence, voice and/or video data can be captured.

Macro level task 210: The individual performing second level verification can ask for more information or clarification, such as, for example, requesting a date of birth of the employee because there is conflicting information in the database. Voice data, keystroke data, image data, etc., can be obtained.

Macro level task 212: The individual performing second level verification can reject the request to add the employee, hence an email can be generated to inform the requestor. Examples of data that can be collected include contents of the autogenerated email, application log data for program autogenerating the email, screen capture, control sequence capture, etc.

Macro level task 214: The individual performing second level verification can approve the request to add the employee, hence an email can be generated to inform the requestor. Same types of data as macro level task 212 can be collected.

Macro level task 220: A steward in the second business unit logs in a computer and opens application C. Same types of data as macro level task 202 can be collected.

Macro level task 222: The steward retrieves requests from a repository (in this case, a request to add the employee to the second business unit). Application logs from application C, logs from the repository, etc., can be collected.

Macro level task 224: Similar to macro level task 206 described above. The employee's credentials are verified.

Macro level task 226: The employee is successfully added to the group once credential verification is successful, and an email can be sent to the requestor indicating success. The email contents can be collected.

Macro level task 228: The employee is not added to the group since credential verification was unsuccessful, and an email with an unsuccessful attempt is sent to the requestor.

The example process map 200 is a graphical illustration where one or more processes can be represented as an n-tuple. For example, a path from macro level task 202 to macro level task 214 can be represented as {202, 204, 206, 208, 214}. The n-tuple representation is one representation that the process mining server 102 can represent processes. The example process provided in FIG. 2 will be used to describe the flow diagram in FIG. 3.

Referring to FIG. 3, a flow diagram 300 showing steps for discovering one or more processes using unsupervised learning is provided, according to some implementations of the present disclosure. At step 302, the process mining server 102 receives multimodal event data from a plurality of sources. Using FIG. 2 as an example, the process mining server 102 can receive keystroke logs, screen captures, application logs, video data, etc. Timestamps may be associated with each of these event data received. For example, if macro level task 210 is performed, keystroke log from the requestor at macro level task 204 can contain earlier keystrokes from when macro level task 204 was first performed. Multimodal event data collected can include event instances or can include SOP. Event instances are actual actions that were taken at some previous time step while an SOP can be an idealized process flow with ideal steps that should be taken.

In some implementations, the multimodal event data can be obtained in batches whereby the process mining server 102 requests data from the one or more data sources 104 at different intervals. In some implementations, the multimodal event data can be obtained in real-time such that the process mining server 102 can monitor progress of one or more processes and adjust hypotheses accordingly.

At step 304, the process mining server 102 associates the multimodal event data with a vector representation. The plurality of event instances (e.g., specific keystrokes, control sequences, etc.) are converted to vectors to obtain a plurality of event vectors. The plurality of event vectors places different event instances in a same space for purpose of comparing and relating the different event instances. Entity vectors can be used to handle multiple different modalities. Each event instance collected is an entity. The vectorizers 108 of the process mining server 102 include a neural network for determining the entity vectors (e.g., a neural network with two parameter matrices followed by an activation function).

In an example, words in sentences can be vectorized or word embeddings can be discovered using the concept of entity vectors. When training a neural network to determine word embeddings, word sequences in a sentence is treated as context. That is, words appearing in use closely together in multiple sentences have a higher probability of having some type of relationship to one another such as similarity, dissimilarity, prefix, suffix, co-occurrence, and association. As such, after discovering the word embeddings and plotting them in a vector space, these word embeddings can be in closer vicinity to each other. Similarly, for discovering business processes, the concept of context can be extended beyond sentences to training of embeddings of user and/or machine actions. A sequence of user and/or machine actions can provide context. The user actions and/or machine actions are collected as multiple modalities as described above in relation to FIGS. 1 and 2. The process mining server 102 treats sequences of user actions and/or machine actions as context in multiple modalities including image, text, audio, video, etc.

In some implementations, concept of entity vectors can be applied to images. For example, the process mining server 102 can compute a 255 dimensional vector on pixel intensity in every image. The process mining server 102 determines frequency of each pixel intensity to obtain the 255 dimensional vector. A 255 dimensional vector from a first image can be compared with a 255 dimensional vector from a second image. For example, a cosine similarity between the two 255 dimensional vectors can be used for similarity analysis, i.e., to determine how similar the two images are to each other.

In an embodiment, the process mining server 102 uses a Visual Geometry Group (VGG) convolutional neural network, e.g., VGG-16 (a type of neural network), to determine image embeddings. For example, using image word representation v from a last fully connected layer of the VGG network, and Wbeing a hidden layer of embedding, a dot product between v and W (v·W) will provide an embedding code for an image.

In some implementations, the concept of entity vectors can be applied to audio (i.e., an audio Word2Vec approach). For example, Chung et al., “Audio word2vec: Unsupervised learning of audio segment representations using sequence-to-sequence autoencoder,” arXiv preprint arXiv:1603.00982 (2016), which is hereby incorporated by reference in its entirety, includes representing audio segments using sequence-to-sequence autoencoder. The sequence-to-sequence autoencoder can accomplish unsupervised learning of Audio Word2Vec from audio data is without human annotation. Determining video embeddings or video entity vectors is an extension of determining image entity vectors previously described. Evaluating the representation of the embeddings in a video is to measure the similarity in frames which contain the representative images.

At step 306, the process mining server 102 correlates the plurality of event vectors using unsupervised learning to determine one or more processes within the multimodal event data. Referring to FIG. 2, step 306 involves identifying the different macro level tasks and identifying the transitions from one task to another. In some implementations, the process mining server 102 can use time windowing to group events into macro level tasks. Time windowing can be performed based on setting regular time intervals and grouping tasks within a same regular time interval. Time windowing can be performed based on events where events that are closer together in time are determined as being related. Time windowing technique for time series analysis and association can help reshape information (or events) initially by fixed windows. In some implementations, this initial approach of using fixed windows provides the most complete information possible in terms of vector embedding at a given time point. The initial fixed window can be later enhanced by sliding window.

In some implementations, when an SOP is provided as one of the multimodal event data, then identified events in the SOP are mapped to the plurality of event instances based on a timing relationship identified in the SOP. The SOP can contain different event names and different divisions, for example, the SOP can group macro level tasks 202 and 204 as one task. The process mining server 102 can use the SOP to restructure FIG. 2 accordingly to match the SOP. The process mining server 102 can also break from the SOP and provide the structure map 200.

Macro level task 204 leads to macro level tasks 206 and 222. Macro level task 206 can be an automated credential verification where a request is made to a database or an authentication server and a response is received. Macro level task 222 on the other hand adds a job to a queue, and the job has to be released manually by an individual who logs on at macro level task 220. The timing between when macro level tasks 206 and 222 occur can be very different. Depending on backlog, macro level task 222 can occur 10 minutes, 30 minutes, 4 hours, a day, two days, etc., after macro level 206.

Furthermore, both macro level tasks 206 and 222 occur at different business units. The process mining server 102 can still relate macro level tasks 206 to macro level task 222 via macro level task 204 due to collecting multimodal data including requests made from application A at macro level task 204. The process mining server 102 can relate macro level tasks 206 and 222 across the business units because of their originating from macro level task 204.

In some implementations, the process {220, 222, 224, 228} or {220, 222, 224, 226} occur much faster than {202, 204, 206, 208, 214} because of macro level tasks 204 and 208 which require people in the loop. In some implementations, the process {202, 204, 206, 208, 214} occurs much faster than {220, 222, 224, 228} or {220, 222, 224, 226} since the individual at macro level task 220 may be out for the week and the employee may not need credentials in the second business unit for at least two months. As such the process {202, 204, 206, 208, 214} is on a low priority. In these such cases, the process mining server 102 can still relate these processes to generate the process map 200.

RNNs recognize patterns in sequences of data. In some implementations, the process mining server 102 can train an RNN using the multimodal data in order to determine a relationship between the different macro level tasks identified in FIG. 2. For example, the process mining server 102 can employ LSTM artificial RNNs for predicting a next macro level task. LSTMs are a special kind of RNN that can learn long-term dependencies and effectively frame sequence prediction problems for RNNs. The process mining server 102 can train the LSTM, such that after seeing that macro level task 208 can occur in any order in relation to macro level task 224 with long time gaps between them, the LSTM can determine that macro level task 224 and macro level task 208 are on different branches and that it is unlikely that macro level task 224 follows macro level task 208 or vice versa. The LSTM can be used to predict that macro level tasks 212, 214, and 210 are most likely to follow macro level task 208.

Training of an RNN/LSTM requires training hyperparameters, i.e., input data, a number of layers of the network, a batch size, a number of training epochs, checkpoints and a final model. The training of the LSTM model is accomplished via backpropagation through time (BPTT), which is suitable for training feed-forward neural networks. BPTT is an enhancement on fixed-sized input-output pairs where sequence data is temporally ordered. Once trained, an LSTM will work for a specific sequence the LSTM was trained for (whether the sequence is a time series or any other recurrence). An example algorightm (pseudocode) for training an LSTM is:

Input: Time sequence input and output pairs to LSTM

Process: Calculate and accumulate errors for each timestep
Update weights

Repeat Input and Process steps.

At step 308, the process mining server 102 generates a process model script for the one or more processes. The process model script can be a robotic process automation (RPA) script. The RPA script can be stored in the process script repository 106 for later use. For example, the RPA script can be used for process automation, graphical process visualization, etc. Graphical representation of the process can be a directed graph, e.g., the directed graph of FIG. 2.

In some implementations, the process model script generated includes probabilities that show most likely pathways. That is, higher probability process pathways are highlighted. For example, in FIG. 2, process {202, 204, 206 208 214} may be highlighted or emphasized while the pathway involving {208, 210, 204} may be deemphasized.

Embodiments of the present disclosure provide several advantages over traditional process mining techniques. For example, in some business entities, candidate activities that can be automated for better return on investment are difficult to identify. Additionally, poor documentation of business processes, lack of understanding of current process flows and their changes over time, and/or deviation from a standard workflow may be reasons contributing to the difficulty. Embodiments of the present disclosure enable identifying processes that may deviate from the standard workflow, allow identifying steps that may not be included in the standard workflow, provide an updated workflow that can be graphically depicted, and can include timing information for identifying areas within the workflow that can be automated.

In some embodiments, the present disclosure provides a system that can extract information from user actions, such as, keypresses and mouse click from the desktop applications as well as applications opened in a web browser. The extracted information is mined at a control level and at a screen level. The system can find user entries or actions performed on each control of an application or a webpage. The system can find a screen level grouping of data with each row containing control details and their values for each page. The additional data being collected provides further insight that can be used in developing one or more processes associated with the user actions.

While the present disclosure has been described with reference to one or more particular implementations, those skilled in the art will recognize that many changes may be made thereto without departing from the spirit and scope of the present disclosure. Each of these embodiments and implementations and obvious variations thereof is contemplated as falling within the spirit and scope of the present disclosure, which is set forth in the claims that follow.

What is claimed is:

1. A system for discovering business processes using unsupervised learning, the system including a non-transitory computer-readable medium storing computer-executable instructions thereon such that when the instructions are executed, the system is configured to:
receive multimodal event data from a plurality of sources, the multimodal event data including a plurality of event instances;
associate the multimodal event data with a vector representation, such that the plurality of event instances is represented as a plurality of event vectors;
correlate the plurality of event vectors using unsupervised learning to identify one or more processes; and
generate a process model script for the one or more processes.

2. The system of claim 1, further configured to correlate the plurality of event vectors by:
joining a first subset of the plurality of event vectors to create a first process matrix,
joining a second subset of the plurality of event vectors to create a second process matrix,
determining a similarity between the first process matrix and the second process matrix, the similarity measured as a dot product between the first process matrix and the second process matrix, and
identifying that the first process matrix and the second process matrix refer to a same process in the one or more processes based on the similarity being below a threshold.

3. The system of claim 1, further configured to correlate the plurality of event vectors by:
joining a first subset of the plurality of event vectors to create a first process matrix,
joining a second subset of the plurality of event vectors to create a second process matrix,
determining a similarity between the first process matrix and the second process matrix, the similarity measured as a dot product between the first process matrix and the second process matrix, and
identifying that the first process matrix and the second process matrix are different processes in the one or more processes based on the similarity being above a threshold.

4. The system of claim 1, further configured to correlate the plurality of event vectors using a long short term memory (LSTM) neural network.

5. The system of claim 1, wherein the process model script includes one or more directed graphs.

6. The system of claim 1, wherein the process model script is a robotic process automation (RPA) script.

7. The system of claim 1, wherein the plurality of sources includes two or more selected from the group consisting of: one or more Internet Information Services (IIS) log files, one or more Apache log file, one or more application log files, one or more standard operating procedure (SOP) manuals, one or more screen capture logs, one or more keystroke logs, one or more business process documents (BPDs).

8. The system of claim 1, wherein the process model script identifies higher probability processes in the one or more processes.

9. A method for discovering business processes using unsupervised learning, the method comprising:
receiving multimodal event data from a plurality of sources, the multimodal event data including a plurality of event instances;
associating the multimodal event data with a vector representation, such that the plurality of event instances is represented as a plurality of event vectors;
correlating the plurality of event vectors using unsupervised learning to identify one or more processes; and
generating a process model script for the one or more processes.

10. The method of claim 9, wherein correlate the plurality of event vectors comprises:
joining a first subset of the plurality of event vectors to create a first process matrix,
joining a second subset of the plurality of event vectors to create a second process matrix,
determining a similarity between the first process matrix and the second process matrix, the similarity measured as a dot product between the first process matrix and the second process matrix, and
identifying that the first process matrix and the second process matrix refer to a same process in the one or more processes based on the similarity being below a threshold.

11. The method of claim 9, wherein correlating the plurality of event vectors comprises:
joining a first subset of the plurality of event vectors to create a first process matrix,
joining a second subset of the plurality of event vectors to create a second process matrix,
determining a similarity between the first process matrix and the second process matrix, the similarity measured as a dot product between the first process matrix and the second process matrix, and
identifying that the first process matrix and the second process matrix are different processes in the one or more processes based on the similarity being above a threshold.

12. The method of claim 9, wherein correlating the plurality of event vectors is performed using a long short term memory (LSTM) neural network.

13. The method of claim 9, wherein the process model script includes one or more directed graphs.

14. The method of claim 9, wherein the process model script is a robotic process automation (RPA) script.

15. The method of claim 9, wherein the plurality of sources includes two or more selected from the group consisting of: one or more Internet Information Services (IIS) log files, one or more Apache log file, one or more application log files, one or more standard operating procedure (SOP) manuals, one or more screen capture logs, one or more keystroke logs, one or more business process documents (BPDs).

16. The method of claim 9, wherein the process model script identifies higher probability processes in the one or more processes.
